(19) United States
(12) Patent Application Publication
(10) Pub. No.: US 2020/0147433 A1
(43) Pub. Date: May 14, 2020

(54) FIRE EXTINGUISHING COMPOSITION

(71) Applicant: Kidde Technologies, Inc., Wilson, NC (US)

(72) Inventors: David William Frasure, Wilson, NC (US); Mark P. Fazzio, Wilson, NC (US); Dharmendr Len Seebaluck, Wake Forest, NC (US); Adam Chattaway, Old Windsor (GB); John Wright Porterfield, JR., Raleigh, NC (US); Tadd F. Herron, Chocowinity, NC (US); Qing Edda Liu, Wake Forest, NC (US)

(21) Appl. No.: 16/674,694

(22) Filed: Nov. 5, 2019

(30) Foreign Application Priority Data
Nov. 9, 2018 (GB) 1818260.0

(51) Int. Cl. A62D 1/06; A62D 1/00

(52) U.S. Cl. CPC A62D 1/06; A62D 1/0092

(57) ABSTRACT

A fire extinguishing composition includes a propellant, a dry chemical fire extinguishing agent and an anti-decomposition agent.

### CROSS REFERENCE TO RELATED APPLICATIONS

This application claims the benefit of United Kingdom Application No. 1818260.0, filed Nov. 9, 2018, which is incorporated by reference in its entirety herein.

### BACKGROUND

Exemplary embodiments pertain to the art of fire extinguishing compositions.

Fire extinguishing compositions are available in a range of types including liquids, solids, gels, and combinations thereof. These compositions have been adapted to a range of delivery systems, flammable material types and environments. There is an ongoing need for fire extinguishing compositions with stable storage profiles.

### BRIEF DESCRIPTION

Disclosed is a fire extinguishing composition including a propellant, a dry chemical fire extinguishing agent and an anti-decomposition agent.

In addition to one or more of the features described above, or as an alternative to any of the foregoing embodiments, the dry chemical fire extinguishing agent includes ammonium sulfate, sodium carbonate, potassium carbonate, sodium bicarbonate, potassium bicarbonate, ammonium borate, ammonium boride, mono- and diammonium phosphate, a combination of carbonates, bicarbonates or both, or a combination of ammonium compounds, diammonium compounds or both.

In addition to one or more of the features described above, or as an alternative to any of the foregoing embodiments, the dry chemical fire extinguishing agent includes an ammonium compound or a carbonate, bicarbonate or a combination thereof.

In addition to one or more of the features described above, or as an alternative to any of the foregoing embodiments, the anti-decomposition agent includes carbon dioxide or ammonia.

In addition to one or more of the features described above, or as an alternative to any of the foregoing embodiments, the anti-decomposition agent is present in an amount greater than 0 and less than or equal to 15 volume percent, based on the total gaseous volume.

In addition to one or more of the features described above, or as an alternative to any of the foregoing embodiments, the composition further includes a leak detection gas.

In addition to one or more of the features described above, or as an alternative to any of the foregoing embodiments, the composition further includes a perfluorocarbon, chlorofluorocarbon, hydrofluorocarbon, hydrochlorofluorocarbon, bromofluorocarbon, hydrobromofluorocarbon, hydrobromofluoro alkene, iodofluorocarbon, combinations thereof, or a gel including one or more of the foregoing.

In addition to one or more of the features described above, or as an alternative to any of the foregoing embodiments, the composition further includes silica, microscopic glass spheres, surfactant, talc, titanium dioxide, or a combination thereof.

Also disclosed is a fire extinguishing composition including a propellant, a bicarbonate fire extinguishing agent and carbon dioxide.

In addition to one or more of the features described above, or as an alternative to any of the foregoing embodiments, the composition further includes a leak detection gas.

In addition to one or more of the features described above, or as an alternative to any of the foregoing embodiments, the carbon dioxide is present in an amount greater than 0 and less than or equal to 15 volume percent, based on the total gaseous volume.

In addition to one or more of the features described above, or as an alternative to any of the foregoing embodiments, the propellant includes nitrogen, helium, argon or a combination thereof.

In addition to one or more of the features described above, or as an alternative to any of the foregoing embodiments, the composition further includes a perfluorocarbon, chlorofluorocarbon, hydrofluorocarbon, hydrochlorofluorocarbon, bromofluorocarbon, hydrobromofluorocarbon, hydrobromofluoro alkene, iodofluorocarbon, combinations thereof, oriira gel including one or more of the foregoing.

In addition to one or more of the features described above, or as an alternative to any of the foregoing embodiments, the composition further includes silica, microscopic glass spheres, surfactant, talc, titanium dioxide, or a combination thereof.

Also disclosed is a fire extinguishing composition including a propellant, an ammonium based fire extinguishing agent and ammonia.

In addition to one or more of the features described above, or as an alternative to any of the foregoing embodiments, the composition further includes a leak detection gas.

In addition to one or more of the features described above, or as an alternative to any of the foregoing embodiments, the ammonia is present in an amount greater than 0 and less than or equal to 15 volume percent, based on the total gaseous volume.

In addition to one or more of the features described above, or as an alternative to any of the foregoing embodiments, the propellant includes nitrogen, argon, carbon dioxide, helium, or a combination thereof.

In addition to one or more of the features described above, or as an alternative to any of the foregoing embodiments, the composition further includes a perfluorocarbon, chlorofluorocarbon, hydrofluorocarbon, hydrochlorofluorocarbon, bromofluorocarbon, hydrobromofluorocarbon, hydrobromofluoro alkene, iodofluorocarbon, combinations thereof, or a gel including one or more of the foregoing.

### DETAILED DESCRIPTION

A detailed description of one or more embodiments of the disclosed composition are presented herein by way of exemplification and not limitation.

Various dry chemical fire extinguishing agents are widely used and are very effective and efficient for extinguishing fires. One drawback to the use of these agents is that they have limited use in environments where the temperatures approach or exceed the point at which the agents begin to decompose. As a result, these extinguishing agents cannot be stored in their fire extinguisher containers at high temperatures as they will start to decompose inside of the fire extinguisher container, and can become ineffective at fighting a fire when they are discharged. These agents can form clumps inside of the container, or may even become a solid agglomerated mass inside of the fire extinguisher container due to the decomposition at high temperatures making the fire extinguisher useless. In addition, sometimes dry chemical agents can decompose to form undesirable byproducts which can damage the fire extinguisher container.

Disclosed herein is a fire extinguishing composition which limits or eliminates decomposition at elevated temperatures by including an anti-decomposition agent. The anti-decomposition agent is a gaseous decomposition product of the dry chemical fire extinguishing agent. By providing a quantity of the dry chemical fire extinguishing agent decomposition product in the initial fire extinguishing composition, the chemical equilibrium between dry chemical fire extinguishing agent and decomposition product is shifted towards the dry chemical fire extinguishing agent and the decomposition temperature of the dry chemical fire extinguishing agent is increased to above the temperatures to which the fire extinguishing composition will be exposed.

Exemplary dry chemical fire extinguishing agents include ammonium sulfate, sodium carbonate, potassium carbonate, sodium bicarbonate, potassium bicarbonate, ammonium borate, ammonium boride, mono- and diammonium phosphate and combinations thereof.

The fire extinguishing composition may comprise one or more additional dry chemical fire extinguishing agents such as potassium borate, sodium borate, sodium sulfate, sodium phosphate, sodium polyphosphate, sodium chloride, and potassium chloride,

The dry chemical fire extinguishing agent is in particle form. In some embodiments the dry chemical fire extinguishing agent has a maximum particle size of 20 to 50 micrometers. In some embodiments the average particle size is 1 to 100 micrometers, or 5 to 50 micrometers, or 1 to 10 micrometers.

When the dry chemical fire extinguishing agent includes a carbonate or bicarbonate compound the anti-decomposition agent includes carbon dioxide. When the dry chemical fire extinguishing agent includes an ammonium compound the anti-decomposition agent includes ammonia. It is contemplated that the dry chemical fire extinguishing agent may include a carbonate compound, a bicarbonate compound, an ammonium compound or any combination thereof. When the dry chemical fire extinguishing agent includes a combination of an ammonium compound and a carbonate compound, bicarbonate compound or both the anti-decomposition agent includes carbon dioxide and ammonia.

The dry chemical fire extinguishing agent is added to the work space of a fire extinguisher device and then the propellant, anti-decomposition agent, optional leak detecting gas, and optional additional fire extinguishing agents are introduced. Exemplary propellants include inert propellant gases and propellant systems. Propellant systems include both internal and external systems. Exemplary inert propellant gases include nitrogen, argon, helium, carbon dioxide and combinations thereof.

The fire extinguishing composition may include an optional leak detection gas. Exemplary leak detection gases include helium. The leak detection gas may be present in an amount of 0.1 to 5 volume percent, based on the total gaseous volume. Within this range the leak detection gas may be present in an amount of 0.5 to 5 vol %.

The anti-decomposition agent may be present in an amount greater than 0 and less than 15 volume percent, based on the total gaseous volume.

The balance of the gaseous volume may be provided by an inert propellant or a propellant system. In some embodiments the propellant is an inert propellant gas.

Optional fire extinguishing agents include perfluorocarbons, chlorofluorocarbons, hydrofluorocarbons, hydrochlorofluorocarbon, bromofluorocarbons, hydrobromofluorocarbon, hydrobromofluoro alkene, iodofluorocarbons, combinations thereof and gels including one or more of the foregoing. The optional fire extinguishing agents can be in liquefied compressed form.

The fire extinguishing composition may further comprise an additive such a silica, microscopic glass spheres, surfactant, talc, titanium dioxide, or a combination thereof.

It is contemplated that the fire extinguishing composition may consist of an inert propellant gas, an optional leak detection gas, a dry chemical fire extinguishing agent, an anti-decomposition agent, and an optional additive. In some embodiments the optional additive may include silica.

The fire extinguishing composition has high temperature stability and effective fire extinguishing capacity at very low weight compared to liquefied compressed gas agents. The fire extinguishing composition also has zero ozone depletion potential and a very low global warming potential making the composition an environmentally attractive option for fire extinguishing.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A fire extinguishing composition comprising a propellant, a dry chemical fire extinguishing agent and an anti-decomposition agent.

2. The composition of claim 1, wherein the dry chemical fire extinguishing agent comprises ammonium sulfate, sodium carbonate, potassium carbonate, sodium bicarbonate, potassium bicarbonate, ammonium borate, ammonium boride, mono- and diammonium phosphate or a combination of carbonates, bicarbonates or both, or a combination of ammonium compounds, diammonium compounds or both.

3. The composition of claim 1, wherein the dry chemical fire extinguishing agent comprises an ammonium compound or a carbonate, bicarbonate or a combination thereof.

4. The composition of claim 3, wherein the anti-decomposition agent comprises carbon dioxide or ammonia.

5. The composition of claim 1, wherein the anti-decomposition agent is present in an amount greater than 0 and less than or equal to 15 volume percent, based on the total gaseous volume.

6. The composition of claim 1, further comprising a leak detection gas.

7. The composition of claim 1, further comprising a perfluorocarbon, chlorofluorocarbon, hydrofluorocarbon, hydrochlorofluorocarbon, bromofluorocarbon, hydrobromofluorocarbon, hydrobromofluoro alkene, iodofluorocarbon, combinations thereof, or a gel comprising one or more of the foregoing.

8. The composition of claim 1, further comprising silica, microscopic glass spheres, surfactant, talc, titanium dioxide, or a combination thereof.

9. A fire extinguishing composition comprising a propellant, a bicarbonate fire extinguishing agent and carbon dioxide.

10. The composition of claim 9, further comprising a leak detection gas.

11. The composition of claim 9, wherein the carbon dioxide is present in an amount greater than 0 and less than 15 volume percent, based on the total gaseous volume.

12. The composition of claim 9, wherein the propellant gas comprises nitrogen, argon, helium or a combination thereof.

13. The composition of claim 9, further comprising a perfluorocarbon, chlorofluorocarbon, hydrofluorocarbon, hydrochlorofluorocarbon, bromofluorocarbon, hydrobromofluorocarbon, hydrobromofluoro alkene, iodofluorocarbon, combinations thereof, or a gel comprising one or more of the foregoing.

14. The composition of claim 9, further comprising silica, microscopic glass spheres, surfactant, talc, titanium dioxide, or a combination thereof.

15. A fire extinguishing composition comprising a propellant, an ammonium fire extinguishing agent and ammonia.

16. The composition of claim 15, further comprising a leak detection gas.

17. The composition of claim 16, wherein the ammonia is present in an amount greater than 0 and less than or equal to 15 volume percent, based on the total gaseous volume.

18. The composition of claim 15, wherein the propellant gas comprises nitrogen, argon, helium, carbon dioxide, or a combination thereof.

19. The composition of claim 15, further comprising a perfluorocarbon, chlorofluorocarbon, hydrofluorocarbon, hydrochlorofluorocarbon, bromofluorocarbon, hydrobromofluorocarbon, hydrobromofluoro alkene, iodofluorocarbon, combinations thereof, or a gel comprising one or more of the foregoing.
